(19) United States
(12) Patent Application Publication
(10) Pub. No.: US 2022/0104315 A1
(43) Pub. Date: Mar. 31, 2022

(54) TEMPERATURE SENSOR ASSEMBLY FOR INDUCTION COOKTOP

(71) Applicant: Whirlpool Corporation, Benton Harbor, MI (US)

(72) Inventors: Salvatore Baldo, Varese (IT); Andrea Gallivanoni, Casorate Sempione (IT); Ajit Manohar, Nagpur (IN); Davide Parachini, Cassano Magnago (IT); Cristiano Vito Pastore, Borgomanero (IT)

(73) Assignee: Whirlpool Corporation, Benton Harbor, MI (US)

(21) Appl. No.: 17/089,878

(22) Filed: Nov. 5, 2020

(30) Foreign Application Priority Data
Sep. 25, 2020 (IN) 202011041810

(51) Int. Cl. H05B 6/06; G01K 1/14; G01K 7/22; H05B 6/12

(52) U.S. Cl. CPC H05B 6/062; G01K 1/14; G01K 2207/00; H05B 6/1209; G01K 7/22

(57) ABSTRACT

An induction cooking apparatus including a cooktop panel, induction coil, controller, and temperature sensor assembly. A temperature sensor and guiding support are positioned in sliding engagement in an opening in the center of the induction coil where an upper end of the temperature sensor sits above a top surface of the induction coil. The controller includes a first circuit board that supplies electricity to the induction coil. A second circuit board, separate from the first circuit board, is electrically connected to the temperature sensor and includes a cantilevered leaf-spring structure that supports the temperature sensor. The guiding support is a load bearing structure that transmits a biasing force created by deflection of the cantilevered leaf-spring structure to the temperature sensor, which operates to hold the temperature sensor in contact with a lower surface of the cooktop panel.

### CROSS-REFERENCE TO RELATED APPLICATIONS

This application claims the benefit of and priority to India Provisional Application No. 202011041810, filed on Sep. 25, 2020. The entire disclosure of the above application is incorporated herein by reference.

### FIELD

The present disclosure relates generally to cooktops, including for example induction cooktops used in residential and commercial kitchens. The present disclosure also relates more specifically to a temperature sensor assembly for a cooktop.

### BACKGROUND

The statements in this section merely provide background information related to the present disclosure and may not constitute prior art.

Induction cooktops are kitchen appliances that exploit the phenomenon of induction heating for food cooking purposes. Conventional induction cooktops include a cooktop panel that is made of glass or a glass-ceramic material. In use, cookware such as pots and pans are positioned on the cooktop panel. Induction cooktops operate by generating an electromagnetic field in a cooking region above the cooktop panel. The electromagnetic field is generated by one or more induction coils made of copper wire, which are driven by a controller that supplies an oscillating electric current to the induction coils. The electromagnetic field induces a parasitic current inside a pot or pan positioned in the cooking region. In order to efficiently heat food utilizing the electromagnetic field, the pot or pan should be made of an electrically conductive ferromagnetic material. The parasitic current circulating in the pot or pan produces heat by Joule effect dissipation. As such, heat is generated only within the pot or pan without directly heating the cooktop panel upon which the pot or pan is placed.

Induction cooktops have a better efficiency than electric cooktops. For example, heating cookware via induction provides for a greater fraction of absorbed energy that is converted into heat that heats the cookware. In operation, the presence of the cookware on the cooktop causes magnetic flux close to the pot or pan resulting in cooking energy being transferred to the cookware. While the primary focus of this disclosure is on induction cooktops, it should be appreciated that the temperature sensor assembly disclosed herein may find utility in other types of cooktops and other consumer appliances. Therefore, it should be understood that the present disclosure is not limited to induction cooktops only.

### SUMMARY

This section provides a general summary of the disclosure, and is not a comprehensive disclosure of its full scope or all of its features.

In accordance with one aspect of the present disclosure, an induction cooking apparatus is described, where the induction cooking apparatus includes an induction coil, a controller, and a temperature sensor. The induction coil includes a top surface and a bottom surface and the temperature sensor includes an upper end that sits above the top surface of the induction coil. The controller may include a first circuit board that is electrically connected to the induction coil and that is configured to supply electricity to the induction coil. The induction cooking apparatus also includes a second circuit board that is electrically connected to the temperature sensor. The second circuit board is separate from the first circuit board and includes a cantilevered leaf-spring structure that supports the temperature sensor. In other words, the first and second circuit boards are physically separated and the second circuit board acts as a standalone circuit board for the temperature sensor.

In accordance with another aspect of the present disclosure, the induction coil may further include an opening that extends through the induction coil from the top surface to the bottom surface. According to this aspect of the disclosure, the temperature sensor is positioned in the opening of the induction coil. It should further be appreciated that multiple induction coils and corresponding temperature sensors may be packaged together in an array for a single cooktop. Advantageously, the cantilevered leaf-spring structure holds the upper end of the temperature sensor flat against a lower surface of a cooktop panel for accurate temperature readings. Because the cantilevered leaf-spring structure is flexible and applies a biasing force to the temperature sensor when flexed, it is configured to accommodate dimensional variations due to manufacturing tolerances and/or the thermal expansion and contraction of components of the cooktop.

By including a second circuit board for the temperature sensor(s), which is separate and distinct from the first circuit board powering the induction coil(s), several advantages are realized. First, packaging constraints on the first circuit board that is electrically connected to the induction coil(s) make it difficult to find room for the cantilevered leaf-spring structure(s) that are connected to the temperature sensor(s). In other words, space is at a premium on the first circuit board powering the induction coil(s). By providing a second circuit board for the temperature sensor(s), sufficient room can be provided on that circuit board for the cantilevered leaf-spring structure(s). In addition, the thickness and material composition of the second circuit board can be selected to specifically provide the desired mechanical properties of the cantilevered leaf-spring structure(s). Because the first circuit board supports many other electrical components, cost and other factors provide constraints of the thickness and material composition of the first circuit board, which are not present when a second, standalone, circuit board is added for the temperature sensors. In addition, it is easier and cheaper to manufacture the cantilevered leaf-spring structure(s) on a second, standalone circuit board compared to trying to incorporate the cantilevered leaf-spring structure(s) on the first circuit board that powers the induction coil(s). Finally, by providing a separate circuit board for the temperature sensors, the cooktop is easier and cheaper to service if a temperature sensor malfunctions because the second circuit board can be replaced more easily and cheaply than the first circuit board to power the induction coils. In addition, the cooktop is also easier and cheaper to assemble, since the temperature sensors, being mounted on a dedicated circuit board, can be assembled by machine instead of by hand, and the whole temperature sensor assembly can then be assembled together with the coil beam assembly.

In accordance with yet another aspect of the present disclosure, a temperature sensor assembly is described where the temperature sensor assembly includes a temperature sensor, a circuit board, and a guiding support. The temperature sensor has an upper end, a lower end, a flange, and one or more wires that extend from the lower end of the temperature sensor. The circuit board includes an electrical circuit that is disposed on a substrate. The circuit board includes a cantilevered leaf-spring structure that is integral with the substrate and that extends to a cantilever end. The wire(s) of the temperature sensor are electrically connected to the electrical circuit at the cantilever end of the cantilevered leaf-spring structure of the circuit board. The guiding support has a top end, a bottom end, and a tubular structure that circumscribes at least a portion of the temperature sensor in a clearance fit. The top end of the guiding support is disposed in contact with the flange of the temperature sensor and the bottom end of the guiding support is disposed in contact with the cantilever end. The substrate is made of a resilient material such that the cantilevered leaf-spring structure of the circuit board provides a biasing force when flexed that is transmitted through the guiding support to the flange at the upper end of the temperature sensor.

In accordance with this particular arrangement, the guiding support is free to slide, tilt, and gimbal relative to the temperature sensor while remaining a load bearing structure that transmits the biasing force created by the deflection of the cantilevered leaf-spring structure to the flange of the temperature sensor. Advantageously, this takes the load off the temperature sensor and specifically the connection between the wire(s) at the lower end of the temperature sensor and the cantilever end. The connection between the wire(s) at the lower end of the temperature sensor and the cantilever end may be, for example, a soldered connection, which can fail under load. Manufacturing is also simplified because the temperature sensor assembly can be assembled separately from the coil beam assembly.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a top plan view of an exemplary cooktop;

FIG. 2 is a top perspective view of an exemplary coil beam assembly that is constructed in accordance with the teachings of the present disclosure;

FIG. 3 is an exploded perspective view of an exemplary cooktop panel, the exemplary coil beam assembly illustrated in FIG. 2, and an exemplary controller;

FIG. 4 is a front cross-sectional view of the exemplary cooktop panel, coil beam assembly, and controller illustrated in FIG. 3;

FIG. 5 is a bottom perspective view of the exemplary cooktop panel, coil beam assembly, and controller illustrated in FIG. 3;

FIG. 6A is a side cross-sectional view of a portion of the exemplary coil beam assembly illustrated in FIG. 3 where a cantilevered leaf-spring structure of a circuit board is shown in an unflexed position;

FIG. 6B is a perspective section view of a portion of the exemplary coil beam assembly illustrated in FIG. 3 where the cantilevered leaf-spring structure of the circuit board is shown in the unflexed position;

FIG. 7A is a side cross-sectional view of a portion of the exemplary cooktop panel and coil beam assembly illustrated in FIG. 3 where the cantilevered leaf-spring structure of the circuit board is shown in a flexed position;

FIG. 7B is a perspective section view of a portion of the exemplary coil beam assembly illustrated in FIG. 3 where the cantilevered leaf-spring structure of the circuit board is shown in the flexed position;

FIG. 8 is an exploded perspective section view of a portion of the exemplary coil beam assembly illustrated in FIG. 3;

FIG. 9 is a top perspective view of an exemplary temperature sensor assembly that is constructed in accordance with the present disclosure, which includes an exemplary temperature sensor and the cantilevered leaf-spring structure of the circuit board shown in FIGS. 6A and 6B; and

FIG. 10 is a bottom perspective view of an exemplary guiding support of the temperature sensor assembly described in the present disclosure.

### DETAILED DESCRIPTION

Referring to the Figures, wherein like numerals indicate corresponding parts throughout the several views, an induction cooking apparatus 20 and temperature sensor assembly 22 for a cooktop 24 are illustrated.

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

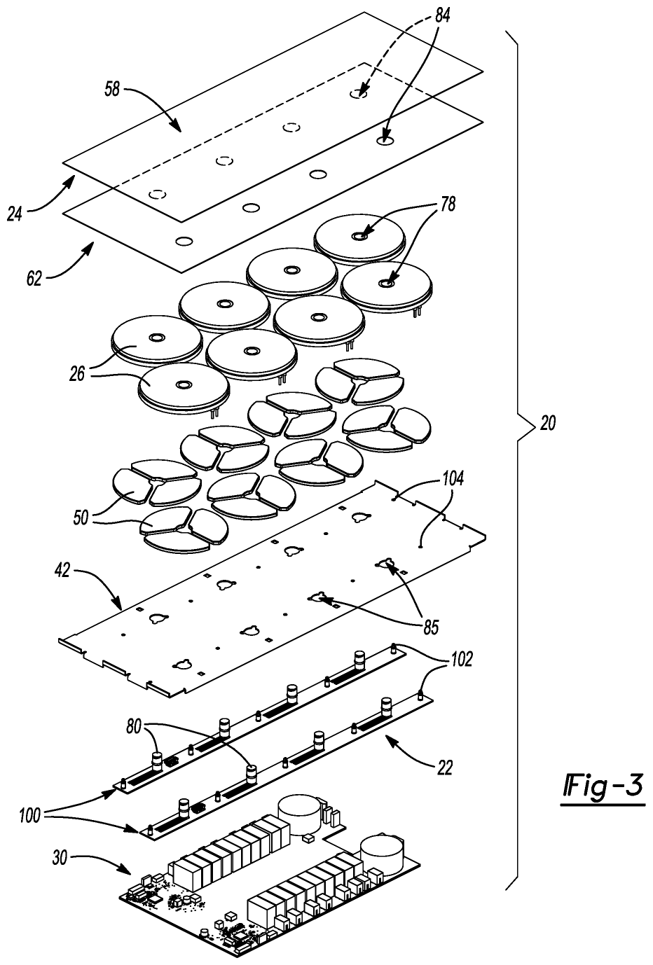

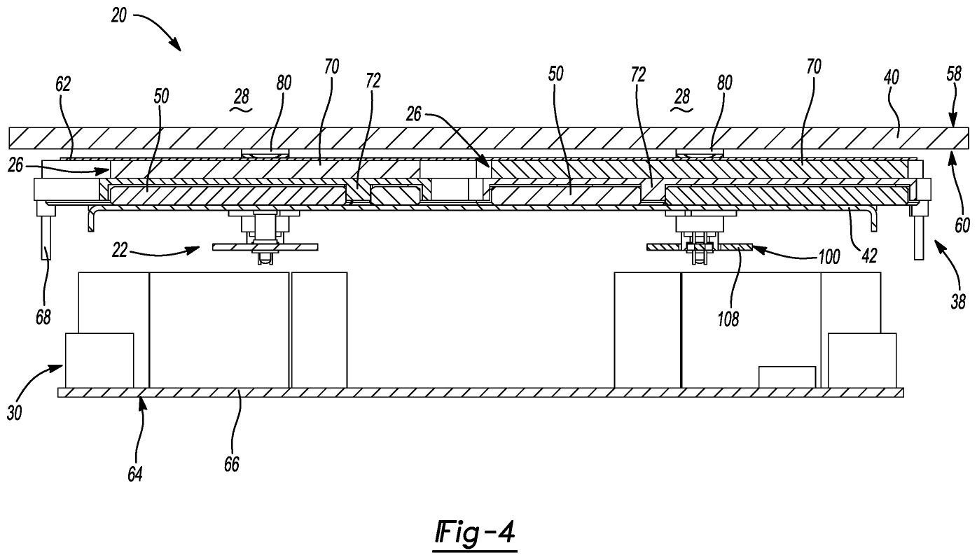

For purposes of description herein the terms “upper,” “lower,” “top,” “bottom,” “vertical,” “horizontal,” and derivatives thereof shall relate to the device as oriented in FIGS. 3 and 4. However, it is to be understood that the apparatus and assemblies described herein may assume various alternative orientations.

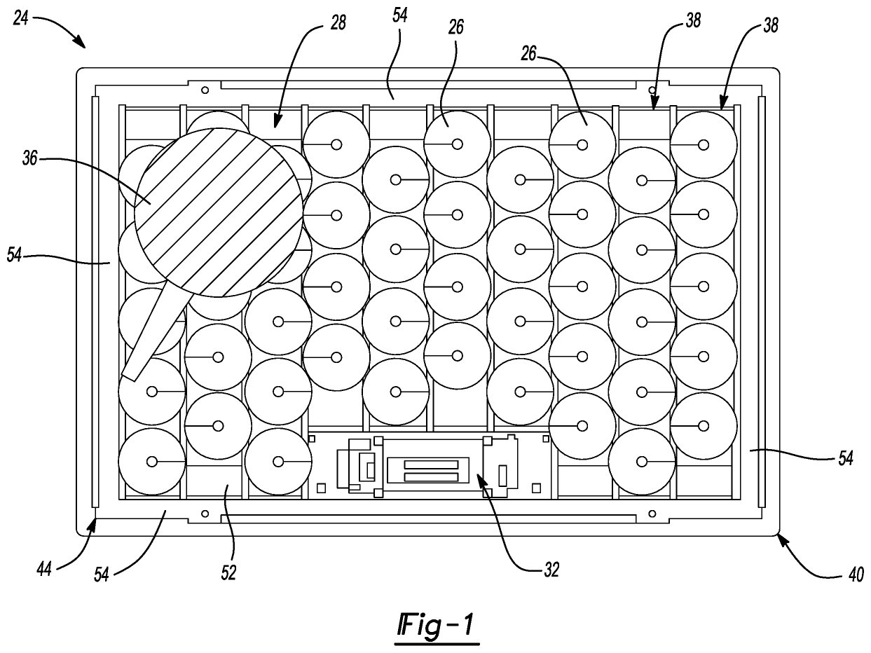

Referring to FIG. 1, the cooktop 24 is shown, as seen from above. In the illustrated embodiment, the cooktop 24 is an induction cooktop that includes an array of induction coils 26 distributed over a cooking region 28. Notwithstanding the illustrated example and the description set forth herein, it should be appreciated that the temperature sensor assembly 22 described herein is not necessarily limited to cooktops that are configured for induction heating and may find utility in other cooktop and consumer appliance applications.

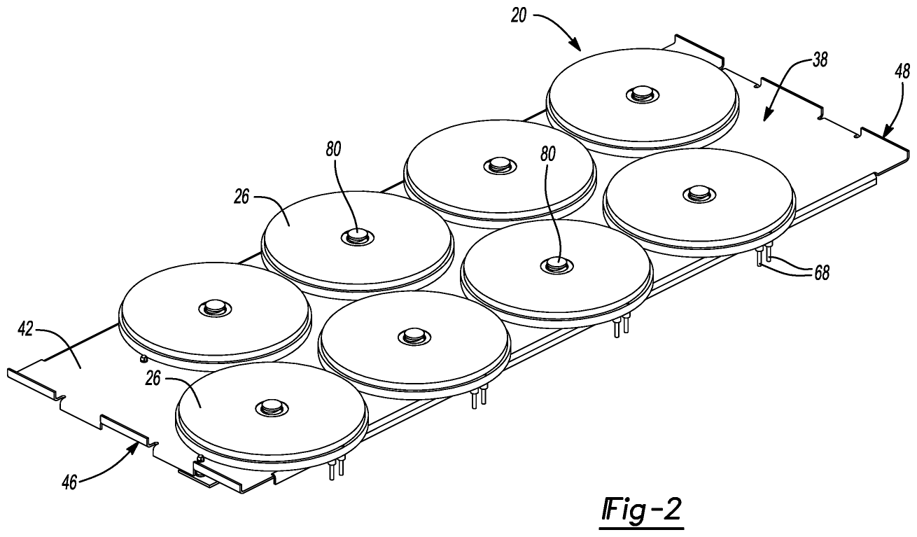

With additional reference to FIGS. 2 and 3, the induction coils 26 are electrically connected to a controller 30. The controller 30 is configured to supply electricity to the induction coils 26. In other words, the controller 30 can selectively activate (i.e. turn on and turn off) the induction coils 26 in response to an input to a user interface 32 that is electrically connected to the controller 30. Optionally, the controller 30 may activate one or more cooking regions 28 formed by the induction coils 26 in response to an input or user selection. As such, the controller 30 may comprise a first electrical circuit 34 that is electrically connected to the induction coils 26. In operation, the first electrical circuit 34 supplies electricity to the induction coils 26 and may include switching devices (e.g. solid state switches) that are configured to generate variable frequency/variable amplitude electric current that is fed to the induction coils 26. In this configuration, the induction coils 26 may be driven such that an electromagnetic field is generated to heat cookware 36 (e.g. pans, pots, etc.) that is placed in an activated cooking region 28.

In some embodiments, the induction coils 26 may be independently activated (i.e., turned on) by the controller 30. Activation of the induction coils 26 may be in response to a user defined heat setting received via the user interface 32 in conjunction with a detection of cookware 36 in the cooking region 28. In response to the user defined setting and the detection of the cookware 36, the controller 30 may activate the induction coils 26 that are covered or partially covered by the cookware 36. Accordingly, the cooktop 24 may provide for the cooking region(s) 28 to be selectively energized providing for a plurality of flexible cooking regions or zones that is sometimes referred to as “cook anywhere” functionality.

The user interface 32 may include one or more of the following components, a dial, touchpad, a digital read out, a digital display, and a touchscreen display. For example, the user interface 32 may correspond to a touch interface configured to perform heat control and selection of the induction coils 26 for a cooking operation. The user interface 32 may comprise a plurality of sensors configured to detect the presence of a finger of an operator proximate thereto. The sensors of the user interface 32 may correspond to various forms of sensors. For example, the sensors of the user interface may correspond to capacitive, resistive, and/or optical sensors. In some embodiments, the user interface 32 may further comprise a display configured to communicate at least one function of the cooktop 24. The display may correspond to various forms of displays, for example, a light emitting diode (LED) display, a liquid crystal display (LCD), etc. In some embodiments, the display may correspond to a segmented display configured to depict one or more alpha-numeric characters to communicate a cooking function of the cooktop 24. The display may further be operable to communicate one or more error messages or status messages from the controller 30.

In some embodiments, the induction coils 26 may be grouped to form coil beam assemblies 38. The coil beam assemblies 38 may be arranged in an alternating, staggered, or complementary arrangement comprising a plurality of coil beam assemblies 38 that are favorably arranged to position the induction coils 26 at evenly spaced or distributed locations in the array. Such even spacing allows the induction coils 26 to evenly distribute cooking energy over the cooking region(s) 28.

As discussed herein, the cooktop 24 may comprise a variety of novel components, both structural and electrical, that provide for improved quality and performance, ease of manufacturing benefits, and cost savings. Though the cooktop 24, induction cooking apparatus 20, and temperature sensor assembly 22 described herein are discussed in reference to specific examples, various components of these assemblies may be implemented alone or in combination.

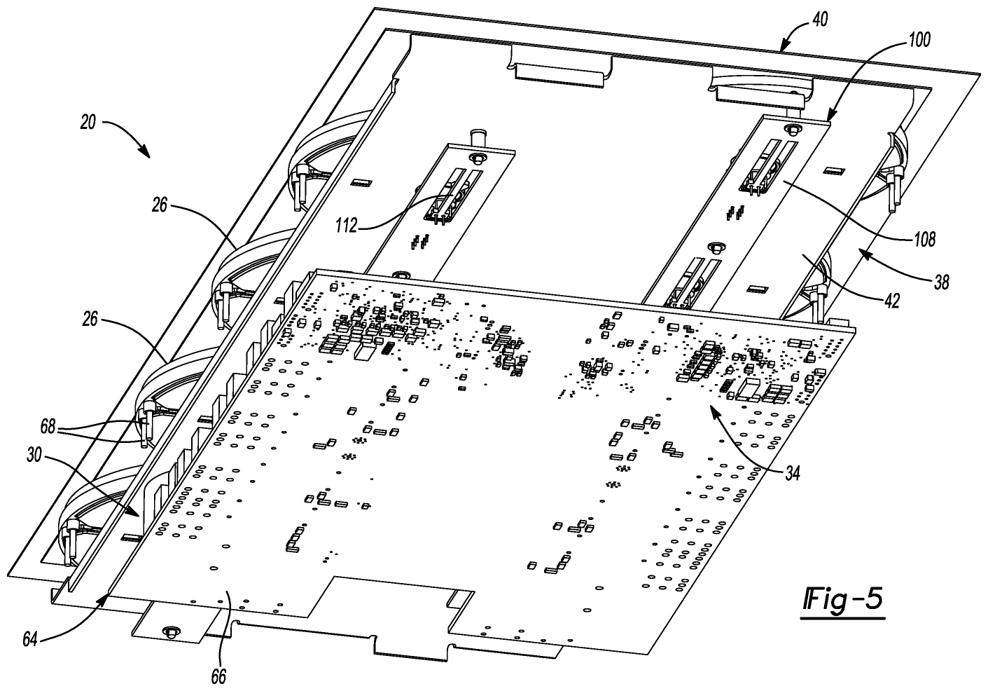

With further reference to FIGS. 4 and 5, the larger induction cooking apparatus 20 is illustrated, which includes the coil beam assembly 38, cooktop panel 40, controller 30, and temperature sensor assembly 22. Each of the induction coils 26 included on one of the coil beam assemblies 38 is mounted above and supported on a beam 42 that extends horizontally/laterally across a burner box 44 of the cooktop 24 between a first beam end 46 and a second beam end 48. The beam 42 may be made from a variety of different materials; however, the beam 42 is preferably made of a non-ferromagnetic material like aluminum, for example, such that the beam 42 is not influenced by the induction coils 26 that it supports. Optionally, ferrite foils 50 may be positioned between each induction coil 26 and the beam 42 to direct the electromagnetic field up towards the cooking region 28.

Although other configurations are possible, the burner box 44 may include a bottom wall 52 and one or more side walls 54 that extend upwardly from the bottom wall 52. Accordingly, the burner box 44 may be substantially rectangular in form and may form an enclosure having an internal cavity configured to house various components of the cooktop 24, including the coil beam assemblies 38. The coil beam assemblies 38 may be supported by the side walls 54 of the burner box 44, where the first and second beam ends 46, 48 engage the side walls 54 of the burner box 44. Alternatively, the coil beam assemblies 38 may be supported in the burner box 44 by a frame or other structure that is supported by the bottom wall 52 and/or side walls 54 of the burner box 44.

The coil beam assemblies 38 extend in complementary parallel groups beneath the cooktop panel 40. The cooktop panel 40 may be made of glass or a glass-ceramic material and includes an upper surface 58 and a lower surface 60. Optionally, a mica sheet 62 may be provided between the lower surface 60 of the cooktop panel 40 and the induction coils 26 to provide insulation. The upper surface 58 of the cooktop panel 40 is configured to support cookware 36 of various shapes and sizes and therefore acts as the cooking surface. The induction coils 26, together with the ferrite foils 50, concentrate a field of electromagnetic flux above the upper surface 58 of the cooktop panel 40 in the cooking region(s) 28.

The controller 30 is positioned beneath the coil beam assembly 38. The controller 30 includes a first circuit board 64 that is electrically connected to the induction coils 26 in the coil beam assembly 38. The first circuit board 64 may be a printed circuit board (PCB) that includes the first electrical circuit 34, which is printed as conductive traces on a first substrate 66 that forms the first circuit board 64. By way of non-limiting example, some materials that may be utilized for the first substrate 66 include, but are not limited to: FR-1, FR-4, FR-5, G-10, and G-11.

The first electrical circuit 34 of the controller 30 is configured to generate one or more high frequency switching signals. The switching signals cause the induction coils 26 to generate the electromagnetic field in cookware 36 placed on the upper surface 58 of the cooktop panel 40. Due to this functionality, the controller 30 may also be referred to as an inverter or an induction power converter. The first electrical circuit 34 includes a plurality of conductive connections and is configured to communicate control signals and/or driving current to the induction coils 26. The conductive connections of the first electrical circuit 34 are arranged in electrical communication with the induction coils 26 via one or more electrical connectors 68 that are electrically connected to copper windings 70 forming the induction coils 26. The electrical connectors 68 may correspond to lead wires (as illustrated) or fast-connect terminals (e.g., “faston” connectors). If the latter option is utilized, the conductive connections of the first electrical circuit 34 may be configured as female terminals and the electrical connectors 68 on the induction coils 26 may be configured as male terminals or vice versa to establish an electrical connection between the first electrical circuit 34 and the induction coils 26.

The copper windings 70 of the induction coils 26 may be wound on coil formers 72. Each coil formers 72 may be, for example, a plastic bobbin or housing. In some embodiments, the copper windings 70 of each induction coil 26 may be wound on one coil former 72. The first electrical circuit 34 may extend along a length of the beam 42 such that the conductive contacts of the first electrical circuit 34 are aligned with the electrical connectors 68 on each induction coil 26. For example, in some embodiments, the induction coils 26 in each coil beam assembly 38 may share a single electrical circuit 34.

During assembly, the coil beam assemblies 38 are positioned over the first circuit board 64 with the electrical connectors 68 of the induction coils 26 aligned with the corresponding conductive contacts of the first electrical circuit 34. Then the coil beam assemblies 38 are lowered such that electrical connectors 68 of the induction coils 26 engage the corresponding conductive contacts of the first electrical circuit 34. The controller 30, including the first circuit board 64, may be mounted to and supported by the bottom wall 52 of the burner box 44 or positioned in a plastic support tray. As previously discussed, the beam 42 is mounted in the burner box 44 at a position that is spaced above the first circuit board 64.

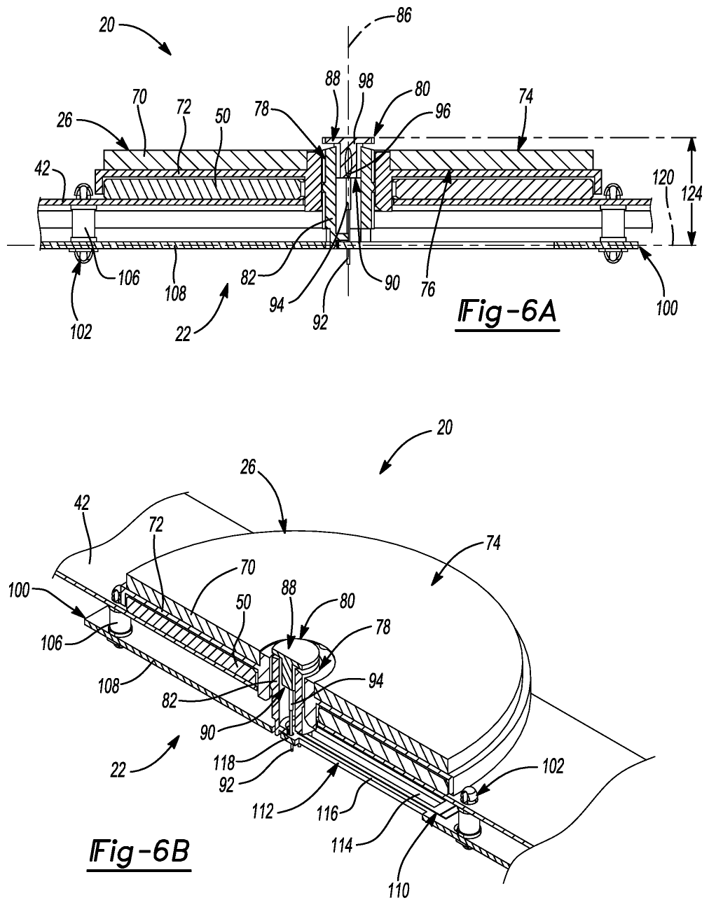

As shown in FIGS. 6A and 6B, each induction coil 26 includes a top surface 74, a bottom surface 76, and an opening 78. The opening 78 extends through the induction coil 26 from the top surface 74 to the bottom surface 76. Although other configurations are possible, each induction coil 26 has a circular, disk-like shape and the opening 78 is located at the center of the induction coil 26. The induction cooking apparatus 20 further includes a temperature sensor 80 for each induction coil 26 that is positioned in the opening 78 of the induction coil 26. A guiding support 82 is also positioned in the opening 78 of the induction coil 26. The temperature sensor 80 and the guiding support 82 are arranged in a clearance fit with one another and the opening 78 such that both the temperature sensor 80 and the guiding support 82 are free to move, slide, and tilt within the opening 78 in the induction coil 26. It should also be appreciated that both the beam 42 and the mica sheet 62 have apertures 84, 85 that are aligned with the openings 78 in the induction coils 26 through which the temperature sensor 80 may extend.

The temperature sensor 80 extends axially along a temperature sensor axis 86 between an upper end 88 and a lower end 90. The upper end 88 of the temperature sensor 80 sits above the top surface 74 of the induction coil 26 and the lower end 90 of the temperature sensor 80 includes one or more wires 92. Optionally, each wire 92 may be encased in an insulator sleeve 94 along part of their length. In some embodiments, the temperature sensors 80 may correspond to negative temperature coefficient (NTC) sensors configured to adjust a resistance based on a temperature proximate to each temperature sensor 80. For example, each temperature sensor 80 may include a thermistor 96 and a sensor enclosure 98 that surrounds at least a portion of the thermistor 96. The sensor enclosure 98 protects the thermistor 96 and may optionally act as an electrical insulator. In operation, the temperature sensors 80 communicate temperature signals for the induction coils 26. These temperature signals are utilized for temperature control and regulation purposes.

The induction cooking apparatus 20 further includes a second circuit board 100, separate from the first circuit board 64, that is electrically connected to the temperature sensor(s) 80. In other words, the induction cooking apparatus 20 has a second, standalone circuit board 100, that together with the temperature sensor 80 and guiding support 82, form the temperature sensor assembly 22 described herein. The second circuit board 100 is mounted above the first circuit board 64 and below the induction coil 26. More specifically, the second circuit board 100 is mounted below the beam 42 and is supported by the beam 42. In some embodiments, connection fixtures 102 are used to connect the second circuit board 100 to the beam 42. By way of example and without limitation, the connection fixtures 102 may extend upward from the second circuit board 100 and may be configured to engage holes 104 in the beam 42. In some embodiments, one of more spacers 106 may be disposed between the beam 42 and the second circuit board 100. The spacers 106 may be made from an electrically insulating material, such as plastic, for example.

The second circuit board 100 includes a second substrate 108 and a second electrical circuit 110 that is disposed on the second substrate 108. For example, the second circuit board 100 may be a printed circuit board (PCB), where the second electrical circuit 110 is formed by conductive traces that are printed on the second substrate 108 of the second circuit board 100. The one or more wires 92 of the temperature sensor 80 are electrically connected to the second electrical circuit 110. For example and without limitation, the wires 92 of the temperature sensor 80 may be soldered to the conductive traces forming the second electrical circuit 110. As such, the second electrical circuit 110 receives the temperature signals from the temperature sensor(s) 80. The second electrical circuit 110 may be configured to process the temperature signals itself or may simply be configured to transmit the temperature signals to the controller 30. Accordingly, in various embodiments, the induction cooking apparatus 20 may include an electronic interface between the first circuit board 64 and the second circuit board 100 that is configured to pass signals (e.g. temperature signals) from the second circuit board 100 to the first circuit board 64.

The second circuit board 100 includes one or more cantilevered leaf-spring structures 112 that support the temperature sensors 80. Each cantilevered leaf-spring structure 112 is integral with the second substrate 108 and is formed by a U-shaped slot 114 that extends through the second circuit board 100. The cantilevered leaf-spring structure 112 therefore operates as a living hinge. The cantilevered leaf-spring structure 112 includes a cantilever arm 116 that extends to a cantilever end 118, which is a free or terminal end that is not connected to the second circuit board 100 except through the cantilever arm 116. The second substrate 108 of the second circuit board 100 is made of a resilient material such that the cantilevered leaf-spring structure 112 can deflect or bend relative to a lateral plane 120 defined by the second circuit board 100. By way of non-limiting example, some materials that may be utilized for the second substrate 108 include but are not limited to: FR-1, FR-4, FR-5, G-10, and G-11.

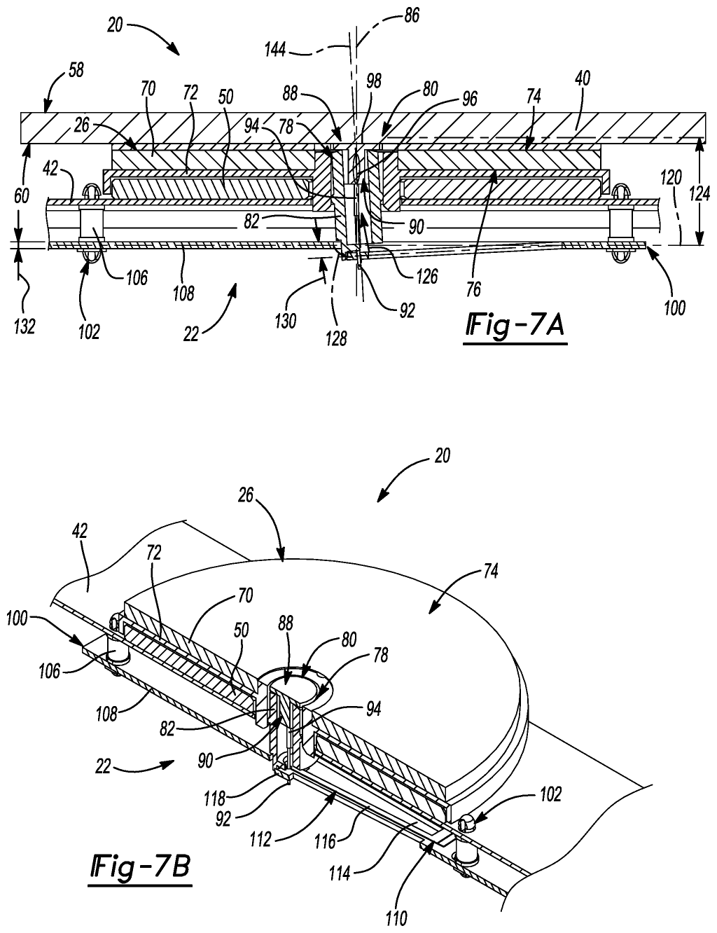

FIGS. 6A and 6B illustrate the cantilevered leaf-spring structure 112 in its natural state before deflection, such as prior to installation of the cooktop panel 40 over the burner box 44. As shown in FIGS. 7A and 7B, after the cooktop panel 40 is installed over the burner box 44, the lower surface 60 of the cooktop panel 40 and the second circuit board 100 are vertically spaced by a predetermined distance 122 that is less than a mounting height 124 of the temperature sensor 80. As a result, when the cooktop 24 is in a fully assembled state, the cantilevered leaf-spring structure 112 is downwardly flexed and applies a biasing force 126 to the temperature sensor 80 that is directed upwards towards the cooktop panel 40. In operation, this biasing force 126 holds the upper end 88 of the temperature sensor 80 flat against the lower surface 60 of the cooktop panel 40 for accurate temperature readings. Because the cantilevered leaf-spring structure 112 is flexible, it accounts for dimensional variations due to manufacturing tolerances and the thermal expansion and contraction of components of the cooktop 24, including during use. When the cantilevered leaf-spring structure 112 flexes, it should be appreciated that the cantilever end 118 travels in an arc shaped path 128, as shown in FIG. 7A.

By including a second circuit board 100 for the temperature sensors 80, which is separate and distinct from the first circuit board 64 powering the induction coils 26, packaging constraints are avoided. For example, space on the first circuit board 64 is crowded by numerous electronic components, making it difficult to find room for the U-shaped slot 114 and cantilevered leaf-spring structure 112 that is connected to each temperature sensor 80. By providing a second circuit board 100 for the temperature sensors 80, sufficient room is created for the cantilevered leaf-spring structures 112. In addition, the thickness and material composition of the second circuit board 100 can be selected to specifically provide the desired mechanical properties of the cantilevered leaf-spring structure(s) 112. In accordance with some embodiments, the second circuit board 100 may be designed such that each cantilevered leaf-spring structure 112 can apply a maximum biasing force 126 of 40-60 grams to each corresponding temperature sensor 80 at a maximum deflection or stroke 130 of 1.0-1.4 millimeters. For example, the second circuit board 100 may be manufactured to have a thickness 132 in the range of 0.8-1.2 millimeters, and be composed of materials with appropriate mechanical properties, such as FR-4. Because the first circuit board 64 supports many other electrical components, cost and other factors provide constraints on the thickness and material composition of the first circuit board 64, which are not present when a second, standalone, circuit board is added for the temperature sensors 80. For example, the industry standard for printed circuit boards in this technology area have a thickness of 1.6 millimeters. As a result, manufacturing efficiencies and cost savings are realized by providing a second, standalone, circuit board for the temperature sensors 80.

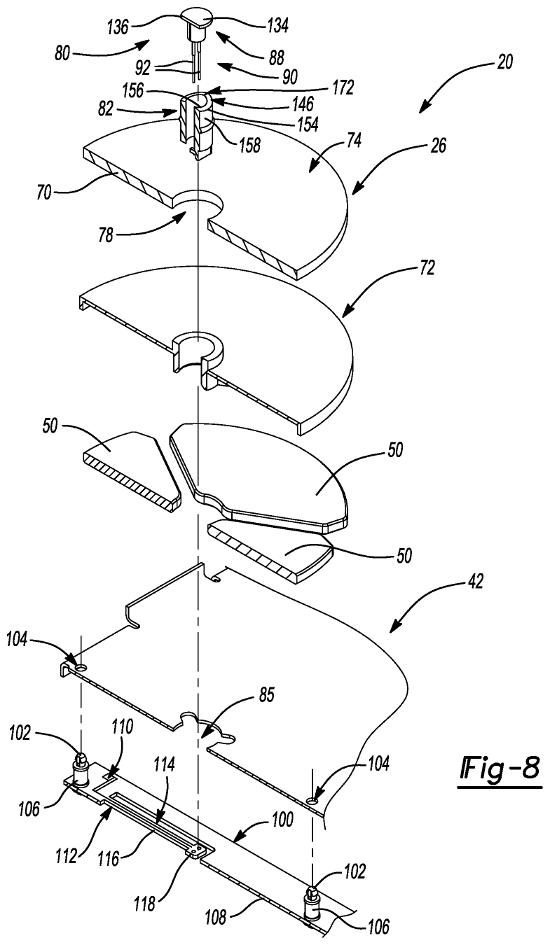

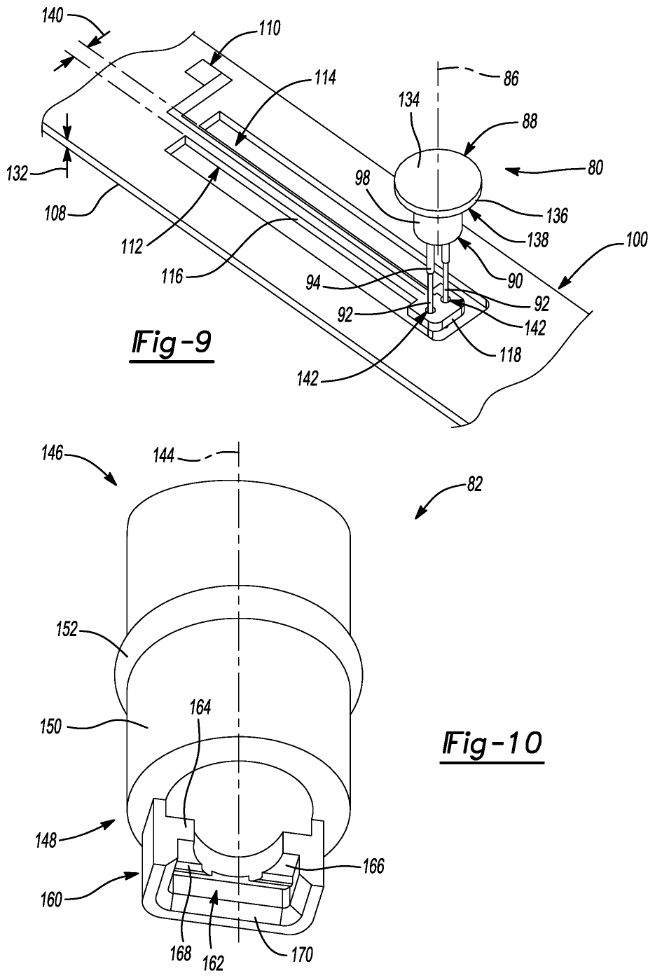

With further reference to FIGS. 8-10, the upper end 88 of the temperature sensor 80 includes a topside surface 134 that contacts the lower surface 60 of the cooktop panel 40 and a flange 136 with an underside surface 138. The flange 136 of the temperature sensor 80 is part of the sensor enclosure 98 as opposed to being part of the thermistor 96. Although other configurations may be possible, in the illustrated embodiment, the cantilever arm 116 has a narrower width 140 than cantilever end 118. In addition, each temperature sensor 80 includes two wires 92 at its lower end 90 that are received in the two holes 142 in the cantilever end 118. Some of the conductive traces forming the second electrical circuit 110 run down the cantilever arm 116 to the cantilever end 118 and the wires 92 of the temperature sensor 80 are electrically connected to the second electrical circuit 110 at the cantilever end 118 by soldering, for example.

The guiding support 82 is positioned in the opening 78 of the induction coil 26 with the temperature sensor 80. The guiding support 82, which may be made of plastic, extends coaxially about a guiding support axis 144 between a top end 146 that is disposed in contact with the upper end 88 of the temperature sensor 80 and a bottom end 148 that is disposed in contact with the cantilevered leaf-spring structure 112 of the second circuit board 100. As a result, the guiding support 82 is load bearing and is configured to transmit the biasing force 126 generated by deflection of cantilevered leaf-spring structure 112 to the upper end 88 of the temperature sensor 80. Although other configurations may be possible, in the illustrated embodiment, the guiding support 82 has a tubular structure that circumscribes at least a portion of the temperature sensor 80 and is positioned in sliding engagement with the opening 78 in the induction coil 26. There is a clearance fit between the guiding support 82 and the temperature sensor 80 and between the guiding support 82 and the opening 78 in the induction coil 26 such that the guiding support 82 is permitted to slide, tilt, and gimbal relative to the temperature sensor 80. Preferably, the tubular structure of the guiding support 82 includes an outer face 150 with an annular rib 152 that provides a sliding point or line contact with the induction coil 26 in the opening 78.

As best seen in FIGS. 7A and 7B, after assembly, the top end 146 of the guiding support 82 is disposed in contact with the flange 136 of the temperature sensor 80 and the bottom end 148 of the guiding support 82 is disposed in contact with the cantilever end 118 such that the biasing force 126 that the cantilevered leaf-spring structure 112 provides when flexed is transmitted through the guiding support 82 to the flange 136 at the upper end 88 of the temperature sensor 80. As best seen in FIG. 8, the top end 146 of guiding support 82 includes an end face 154 that is bounded by an inner circumferential edge 156 and an outer circumferential edge 158. Preferably, the end face 154 is chamfered (i.e., sloped) with a peak formed at a top edge 172, which in illustrated example extends radially across the end face 154 from inner circumferential edge 156 to the outer circumferential edge 158. In accordance with this arrangement, the top edge 172 of the end face 154 provides a sliding point or line contact with an underside surface 138 of the flange 136 of the temperature sensor 80. In other words, a line contact between the top edge 172 of the guiding support 82 and the underside surface 138 of the flange 136 of the temperature sensor 80 may be provided when the guiding support axis 144 is perpendicular to the flange 136 such as when the top edge 172 is resting flat against the underside surface 138 of the flange 136.

As best seen in FIG. 10, the bottom end 148 of the guiding support 82 includes an engagement feature 160 that extends downwardly from the tubular structure of the guiding support 82. The engagement feature 160 at the bottom end 148 of the guiding support 82 defines a pocket 162 that receives the cantilever end 118 of the cantilevered leaf-spring structure 112 in a sliding fit. As a result, the engagement feature 160 and the cantilever end 118 cooperate to form a free fitting hinge between the guiding support 82 and the cantilevered leaf-spring structure 112, which permits the guiding support 82 to slide, tilt, and gimbal relative to the temperature sensor 80 and cantilevered leaf-spring structure 112. The engagement feature 160 includes a shoulder 164 that defines a bottom face 166 of the pocket 162. Preferably, the bottom face 166 includes a straight rib 168 that provides a sliding point or line contact with the cantilever end 118. The engagement feature 160 may also include a bottom inside edge 170 that is chamfered to aid in assembly and permit a greater range of movement between the guiding support 82 and the cantilever end 118.

In accordance with this arrangement, the guiding support 82 is free to slide, tilt, and gimbal relative to both the temperature sensor 80 and the cantilevered leaf-spring structure 112 while remaining a load bearing structure that transmits the biasing force 126 created by the deflection of the cantilevered leaf-spring structure 112 to the flange 136 at the upper end 88 of the temperature sensor 80. Said another way, the guiding support 82 can move and tilt independently of the temperature sensor 80 and the cantilevered leaf-spring structure 112. Advantageously, this takes the load off the temperature sensor 80 and specifically the connection between the wires 92 at the lower end 90 of the temperature sensor 80 and the cantilever end 118. As previously explained, the connection between the wires 92 at the lower end 90 of the temperature sensor 80 and the cantilever end 118 may be, for example, a soldered connection, which can fail under load. In operation, the guiding support 82 takes the load of the wires 92 and this connection and therefore provides greater durability.

Many modifications and variations of the apparatus and assemblies described in the present disclosure are possible in light of the above teachings and may be practiced otherwise than as specifically described while within the scope of the appended claims. These antecedent recitations should be interpreted to cover any combination in which the inventive novelty exercises its utility. In addition, the reference numerals in the claims are merely for convenience and are not to be read in any way as limiting.

What is claimed is:

1. An induction cooking apparatus comprising:
an induction coil with a top surface;
a controller including a first circuit board that is electrically connected to said induction coil and that is configured to supply electricity to said induction coil;
a temperature sensor having an upper end that sits above said top surface of said induction coil; and
a second circuit board, separate from said first circuit board, that is electrically connected to said temperature sensor, said second circuit board including a cantilevered leaf-spring structure that supports said temperature sensor.

2. The induction cooking apparatus as set forth in claim 1, wherein said second circuit board includes a substrate and said cantilevered leaf-spring structure is integral with said substrate of said second circuit board.

3. The induction cooking apparatus as set forth in claim 2, further comprising:
a cooktop panel positioned above said induction coil,
said cooktop panel having an upper surface and a lower surface; and
said substrate of said second circuit board being made of a resilient material such that said cantilevered leaf-spring structure applies a biasing force to said temperature sensor when flexed to operably hold said upper end of said temperature sensor in contact with said lower surface of said cooktop panel.

4. The induction cooking apparatus as set forth in claim 3, wherein said lower surface of said cooktop panel and said second circuit board are vertically spaced by a predetermined distance that is less than a mounting height of said temperature sensor such that said cantilevered leaf-spring structure is downwardly flexed in a fully assembled state and said biasing force of said cantilevered leaf-spring structure is directed upwards towards said cooktop panel.

5. The induction cooking apparatus as set forth in claim 3, wherein said cooktop panel is made of glass or a glass-ceramic material and said upper surface of said cooktop panel is configured to support cookware.

6. The induction cooking apparatus as set forth in claim 2, wherein said second circuit board includes a second electrical circuit that is disposed on said substrate and that is electrically connected to said temperature sensor.

7. The induction cooking apparatus as set forth in claim 1, wherein said second circuit board is mounted above said first circuit board and below said induction coil.

8. The induction cooking apparatus as set forth in claim 7, further comprising:
a beam extending laterally between a first beam end and a second beam end,
wherein said induction coil is mounted above said beam and is supported by said beam, and
wherein said second circuit board is mounted below said beam and is supported by said beam.

9. The induction cooking apparatus as set forth in claim 8, further comprising:
a burner box having a bottom wall and side walls that extend upwardly from said bottom wall,
wherein said controller is mounted to and supported by said bottom wall of said burner box, and
wherein said beam is supported within said burner box at a position that is spaced above said first circuit board.

10. An induction cooking apparatus comprising:
an induction coil with a top surface, a bottom surface, and an opening that extends through said induction coil from said top surface to said bottom surface;
a controller including a first circuit board that is electrically connected to said induction coil and that is configured to supply electricity to said induction coil;
a temperature sensor positioned in said opening of said induction coil, said temperature sensor having an upper end that sits above said top surface of said induction coil; and
a second circuit board, separate from said first circuit board, that is electrically connected to said temperature sensor, said second circuit board including a cantilevered leaf-spring structure that supports said temperature sensor.

11. The induction cooking apparatus as set forth in claim 10, further comprising:
a guiding support positioned in said opening of said induction coil with said temperature sensor;
said guiding support including a top end that is disposed in contact with said upper end of said temperature sensor and a bottom end that is disposed in contact with said cantilevered leaf-spring structure of said second circuit board such that said guiding support is load bearing and is configured to transmit a biasing force generated by deflection of said cantilevered leaf-spring structure to said upper end of said temperature sensor.

12. The induction cooking apparatus as set forth in claim 11, wherein said guiding support has a tubular structure that circumscribes at least a portion of said temperature sensor and is positioned in sliding engagement with said opening in said induction coil.

13. The induction cooking apparatus as set forth in claim 12, wherein there is a clearance fit between said guiding support and said temperature sensor and between said guiding support and said opening in said induction coil such that said guiding support is permitted to slide, tilt, and gimbal relative to said temperature sensor.

14. A temperature sensor assembly for a cooktop comprising:
a temperature sensor having an upper end, a lower end, a flange, and at least one wire that extends from the lower end;
a circuit board having an electrical circuit that is disposed on a substrate;
said circuit board including a cantilevered leaf-spring structure that is integral with said substrate and that extends to a cantilever end;
said at least one wire of said temperature sensor being electrically connected to said electrical circuit at said cantilever end; and
a guiding support having a top end, a bottom end, and a tubular structure that circumscribes at least a portion of said temperature sensor in a clearance fit,
wherein said top end of said guiding support is disposed in contact with said flange of said temperature sensor, said bottom end of said guiding support is disposed in contact with said cantilever end, and said substrate is made of a resilient material such that said cantilevered leaf-spring structure provides a biasing force when flexed that is transmitted through said guiding support to said flange of said temperature sensor.

15. The temperature sensor assembly as set forth in claim 14, wherein said bottom end of said guiding support includes an engagement feature that extends downwardly from said tubular structure of said guiding support and that defines a pocket that receives said cantilever end of said cantilevered leaf-spring structure in a sliding fit such that said engagement feature and said cantilever end cooperate to form a free fitting hinge between said guiding support and said cantilevered leaf-spring structure that permits said guiding support to slide, tilt, and gimbal relative to said temperature sensor.

16. The temperature sensor assembly as set forth in claim 15, wherein said pocket includes a bottom face with a straight rib that provides a sliding point or line contact with said cantilever end.

17. The temperature sensor assembly as set forth in claim 14, wherein said guiding support is configured to be received in an opening in a component of said cooktop and wherein said tubular structure of said guiding support includes an outer face with an annular rib that provides a sliding point or line contact with said component that defines said opening.

18. The temperature sensor assembly as set forth in claim 14, wherein said top end of said guiding support includes an end face that is bounded by an inner circumferential edge and an outer circumferential edge and wherein said end face is chamfered such that a sliding point or line contact is created between said end face of said guiding support and said flange of said temperature sensor.

19. The temperature sensor assembly as set forth in claim 14, wherein said temperature sensor includes a thermistor and a sensor enclosure that surrounds at least a portion of said thermistor and wherein said flange of said temperature sensor is part of said sensor enclosure.

20. The temperature sensor assembly as set forth in claim 14, wherein said cantilevered leaf-spring structure includes a cantilever arm that has a narrower width than said cantilever end and wherein said cantilever end includes at least one hole that receives said at least one wire of said temperature sensor.
